(19) United States
(12) Patent Application Publication
(10) Pub. No.: US 2015/0192718 A1
(43) Pub. Date: Jul. 9, 2015

(54) INFRARED SHIELDING FILM HAVING DIELECTRIC MULTILAYER FILM STRUCTURE

(71) Applicant: Konica Minolta, Inc., Tokyo (JP)

(72) Inventors: Makiko Saito, Tokyo (JP); Akihisa Nakajima, Tokyo (JP)

(73) Assignee: Konica Minolta, Inc., Tokyo (JP)

(21) Appl. No.: 14/412,891

(22) PCT Filed: Jul. 5, 2013
(86) PCT No.: PCT/JP2013/068523

§ 371 Date: Jan. 5, 2015

(30) Foreign Application Priority Data
Jul. 10, 2012 (JP) 2012-154948

(51) Int. Cl. G02B 5/28

(52) U.S. Cl. CPC G02B 5/282; Y02B 80/20

(57) ABSTRACT

Provided is an infrared reflective film which has excellent insulating effects in the summer season and excellent heat retention effects in the winter season. Further, provided is an infrared shielding film in which the risk of heat cracks can be reduced by preventing heat generation on the film and which can be easily pasted.

An infrared shielding film having a dielectric multilayer film (A), a dielectric multilayer film (B) and a non-interference layer disposed between the dielectric multilayer film (A) and the dielectric multilayer film (B), wherein the dielectric multilayer film (A) has the maximum reflectance value, which has a reflectance of 50% or more, in the wavelength region of 900 to 1100 nm, and the dielectric multilayer film (B) has the maximum reflectance value in the wavelength region of 1200 to 2100 nm, and any one layer other than the dielectric multilayer film (A) and the dielectric multilayer film (B) contains an infrared absorber, and the surface on which the dielectric multilayer film (A) is laminated is installed to face the outdoor side.

### TECHNICAL FIELD

The present invention relates to an infrared shielding film having a dielectric multilayer film structure.

### BACKGROUND ART

In order to suppress infrared light penetration and prevent an excessive increase in room temperature, window films are utilized, which are laminated on the surfaces of a building window glass and a car window glass. In the summer season, particularly, energy is saved by reducing the use of air-conditioning.

When the above-mentioned window films are classified based on methods for shielding infrared rays, an infrared ray absorption type film in which an infrared ray absorbing layer containing an infrared absorber is applied to a film, an infrared reflection type film in which a layer to reflect infrared rays is applied to a film, and a film which has both functions are known.

JP A 2002-210855, for example, discloses an infrared ray absorption type film which is coated with a heat ray shielding resin composition having inorganic metal microparticles with heat ray absorbing power (such as tin oxide, ATO (antimony tin oxide), ITO (indium tin oxide) etc.). U.S. Pat. No. 7,632,568 discloses a film having a coating in which a high refractive index layer and a low refractive index layer are alternately laminated, and further having a layer containing ATO.

Further, U.S. Pat. No. 6,391,400 discloses an infrared reflective film having a multilayer film which has different reflective wavelength regions between one side and another side of a base.

There is an attempt to block incident heat from outdoors in the summer season, while it is also required not to release heat by indoor heating to the outdoor side in the winter season. The indoor heat is not released in the winter season, thereby being able to keep a room warm and reduce the use of heating, which is effective for energy saving.

### SUMMARY OF INVENTION

### Technical Problem

In a heat ray shielding film having microparticles of inorganic metal with heat ray absorbing power, microparticles with heat ray absorbing power have a very wide absorption wavelength region in many cases. Consequently, the film has been able to be easily produced by a simple layer constitution in many cases and relatively easily pasted.

When a film with heat ray absorbing power is pasted on a window, however, the film itself absorbs infrared rays, which change to heat energy. Due to the heat, the temperature of the glass is increased and strain inside the glass becomes large. In particular, a temperature difference easily occurs between the glass of the sash part and the glass of the solar radiation part of the window. Consequently, the phenomenon of “heat cracks” that a glass is broken becomes a problem. The reason is that because the parts inserted between the sashes in the glass do not directly receive solar radiation and heat is released to the sashes, the temperature in the parts is hard to increase compared to the solar radiation part on which the film is pasted. In addition, the heat crack is a phenomenon which occurs by not only heat rays dominated by near infrared rays contained in solar radiation, but also heat rays dominated by far infrared rays emitted from room heating. In the winter season when outdoor temperature is low, in particular, heat cracks can occur because the sash part is sufficiently cooled but the glass temperature in the part on which a film is pasted is increased due to the heat of heating.

The occurrence of heat cracks depends on the amount of heat generation of a film, and thus such risk is low in an infrared reflection type film with a smaller amount of infrared rays absorbed than that in an infrared ray absorption type. In a film in U.S. Pat. No. 7,632,568, however, light rays in the wide wavelength region from near infrared to far infrared are shielded by a constitution in which an infrared light absorbing nanoparticle layer adjoining to alternate reflective layers is provided, and rays reflecting on the reflective layers are in the wavelength region of approximately 850 nm to 1200 nm and light rays in wavelengths over the region are absorbed on the infrared light absorbing layer. Therefore, there has been a problem in that the risk of heat cracks is not sufficiently excluded because of a large absorption amount of heat.

In addition, in the case in which a reflective layer exists on only one side of an infrared absorbing layer like U.S. Pat. No. 7,632,568, the risk of heat cracks is reduced only when the reflective layer is close to the heat ray penetration side compared to the infrared absorbing layer. This has been insufficient because the effect is shown only for heat cracks by either solar radiation from outdoors or the heat of indoor heating. That is, when the reflective layer is close to the outdoor side compared to the infrared absorbing layer, the risk of heat cracks due to the heat of indoor heating cannot be reduced, and contrarily when the reflective layer is close to the indoor side compared to the infrared absorbing layer, the risk of heat cracks due to solar radiation from outdoors cannot be reduced.

In U.S. Pat. No. 7,632,568, further, a film absorbs heat rays in the wavelength region of mid-far infrared rays which people feel warm and thus heating will be further used to maintain warmth. Therefore, there is plenty of room for improvement from the viewpoint of saving energy.

In a film in U.S. Pat. No. 6,391,400, different wavelength regions are shielded by an infrared reflective layer obtained by multilayer lamination. When reflection is carried out by multilayer lamination, however, it is required to make a complicated layer constitution to obtain desired optical characteristics. Consequently, there have been problems in that production is not easy and a thick film is obtained.

In addition, there is a technique to provide an infrared reflective film between a double glass and a laminated glass; however, when the film touches one of the glasses, the risk of heat cracks cannot be solved as mentioned above. In addition, in order to prevent heat cracks, it can be thought that a film is provided in the isolated state between a double glass; however, the cost to incorporate the film into a double glass is very high and it is not realistic.

Therefore, the present invention is made in view of the above-mentioned problems, and an object thereof is to provide an infrared shielding film which has excellent insulating effects in the summer season and excellent heat retention effects in the winter season. Another object of the present invention is to provide an infrared shielding film which is easily pasted, in which the risk of heat cracks is reduced even when an infrared absorber is used and film separation during storing is reduced.

### Means for Solving Problem

The object of the present invention is achieved by the following aspect.

An infrared shielding film having a dielectric multilayer film (A), a dielectric multilayer film (B) and a non-interference layer disposed between the dielectric multilayer film (A) and the dielectric multilayer film (B),

wherein the dielectric multilayer film (A) has the maximum reflectance value, which has a reflectance of 50% or more, in the wavelength region of 900 to 1100 nm, and the dielectric multilayer film (B) has the maximum reflectance value in the wavelength region of 1200 to 2100 nm,

anyone layer other than the dielectric multilayer film (A) and the dielectric multilayer film (B) contains an infrared absorber, and the surface on which the dielectric multilayer film (A) is laminated is installed to face the outdoor side.

### BRIEF DESCRIPTION OF DRAWINGS

FIG. 1 is a cross-sectional schematic diagram showing the constitution of an infrared shielding film involved in an embodiment of the present invention which is used for a window glass on the indoor side.

FIG. 2 is a cross-sectional schematic diagram showing the constitution of an infrared shielding film involved in an embodiment of the present invention which is used for a window glass on the outdoor side.

FIG. 3 is a cross-sectional schematic diagram showing the constitution of an infrared shielding film involved in an embodiment of the present invention which is used for a laminated glass.

FIG. 4 is a cross-sectional schematic diagram showing the constitution of an infrared shielding film which is used in Comparative Example 2.

FIG. 5 is a cross-sectional schematic diagram showing the constitution of an infrared shielding film which is used in Comparative Example 4.

FIG. 6 is a cross-sectional schematic diagram showing the constitution of an infrared shielding film which is used in Comparative Example 3.

FIG. 7 is a reflection spectrum of a dielectric multilayer film (A) and a dielectric multilayer film (B).

### DESCRIPTION OF EMBODIMENTS

The embodiments for carrying out the present invention will now be described.

A first embodiment of the present invention is an infrared shielding film having a dielectric multilayer film (A), a dielectric multilayer film (B) and a non-interference layer disposed between the dielectric multilayer film (A) and the dielectric multilayer film (B), wherein the dielectric multilayer film (A) has the maximum reflectance value, which has a reflectance of 50% or more, in the wavelength region of 900 to 1100 nm, and the dielectric multilayer film (B) has the maximum reflectance value in the wavelength region of 1200 to 2100 nm, and any one layer other than the dielectric multilayer film (A) and the dielectric multilayer film (B) contains an infrared absorber, and the surface on which the dielectric multilayer film (A) is laminated is installed to face the outdoor side.

According to the present invention, there is provided a film which has excellent infrared shielding properties and is suitable for annual climatic changes by containing a dielectric multilayer film (A), a dielectric multilayer film (B), a non-interference layer between them and an infrared absorber. That is, there is provided an infrared reflective film which has excellent insulating effects in the summer season and excellent heat retention effects in the winter season. Further, by using a dielectric multilayer film (A) having a specific reflectance, the heat generation of the film is prevented, thereby the risk of heat cracks is reduced. In addition, an infrared shielding film which has a simple layer constitution and is thinner is actualized and thus can be easily pasted on a window glass and the like, and film separation during storing can be prevented.

The infrared shielding film of the present invention includes a dielectric multilayer film (A) and a dielectric multilayer film (B), and includes a non-interference layer between such dielectric multilayer film (A) and such dielectric multilayer film (B) in order that optical characteristics generated from the dielectric multilayer film (A) and the dielectric multilayer film (B) will not interfere with each other. When the non-interference layer is not provided and the dielectric multilayer film (B) is directly formed on the dielectric multilayer film (A), due to a mutual optical interaction, novel reflection characteristics as a third layer are usually shown as a whole. Therefore, the non-interference layer is required to constitute an infrared shielding film independently showing each reflection characteristics of dielectric multilayer films (A) and (B).

In addition, the dielectric multilayer film (A) involved in the present invention has the maximum reflectance value, which has a reflectance of 50% or more, in the wavelength region of 900 to 1100 nm, and the dielectric multilayer film (B) involved in the present invention has the maximum reflectance value in the wavelength region of 1200 to 2100 nm. Herein, the maximum reflectance value used in the present invention means a value when the reflectance is largest in the wavelength region defined above in a reflection spectrum. When the dielectric multilayer film (A) has a maximum reflectance value of 50% or more in the above-mentioned range, the shape of a reflection spectrum is not concerned. For example, a reflection spectrum may have a plurality of peaks other than the maximum reflectance value, wherein the plurality of peaks is smaller than that of the maximum reflectance value. When the dielectric multilayer film (B) has a maximum reflectance value in the above-mentioned range, the shape of a reflection spectrum itself is also not concerned.

In addition, when the dielectric multilayer films (A) and (B) each meet the above-mentioned requirements, reflection characteristics in other wavelength regions are not concerned. For example, the dielectric multilayer film (A) may further show any level of reflectance in 1200 to 2100 nm which is the same as of the dielectric multilayer film (B). In general, however, when a dielectric multilayer film showing a high reflectance in a wide wavelength region is produced, the layer constitution thereof becomes thick and complicated. Therefore, the dielectric multilayer films (A) and (B) are each not required to show a high reflectance beyond the range of the above-mentioned wavelength region in terms of ease of production and ease of pasting of a film.

Further, any one layer other than the dielectric multilayer films (A) and (B) involved in the present invention contains an infrared absorber. The dielectric multilayer film (A) involved in the present invention is installed to face the outdoor side, that is, the dielectric multilayer film (B) involved in the present invention is installed to face the indoor side on the surface opposite to the surface of a non-interference layer on which the dielectric multilayer film (A) is installed. Thus, an infrared shielding film which has excellent insulating effects in the summer season and excellent heat retention effects in the winter season and is easily pasted, in which the risk of heat cracks is reduced, can be actualized.

A mechanism to show the main action effects by the above-described constitution of the present invention is supposed as described below.

That is, the dielectric multilayer film (A) involved in the present invention reflects heat rays (in particular, near infrared light) from sunlight of the outdoor side (outside a room or a car) in the summer season, and thus the heat absorption of the infrared shielding film of the present invention can be suppressed and the risk of heat cracks can be reduced, as well as the load to cooling equipment can be also decreased. Even when there are heat rays which are not reflected by the dielectric multilayer film (A) involved in the present invention, an infrared absorber contained in the infrared shielding film of the present invention plays a role to absorb such infrared rays. Thus, an infrared shielding film which can shield infrared rays in the wider wavelength region and has more excellent insulating effects is actualized. However, 50% or more of near infrared rays are previously reflected on the dielectric multilayer film (A), and thus the amount absorbed by the infrared absorber is less than that of a case in which the dielectric multilayer film (A) is not used. Therefore, the problem of heat cracks on a window glass and the like, which has been caused by a conventional infrared shielding film containing an infrared absorber, can be prevented in the present invention. On the other hand, in the winter season, the risk of heat cracks by heat rays from sunlight can be reduced as is the case with the summer season. Further, the dielectric multilayer film (B) involved in the present invention reflects mid-far infrared rays emitted by indoor (in a room or a car) heating, and thus the heat absorption of the film is suppressed and the risk of heat cracks is reduced as is the case with sunlight. Further, heat rays in the wavelength region of mid-far infrared rays, which people feel warm, are returned to indoors by reflection and thus indoor heating efficiency can be increased.

In the case in which an infrared absorber-containing layer is disposed, when heat rays from outdoors in the summer season are intensively shielded, it is preferred that the infrared absorber-containing layer be disposed close to the indoor side compared to a dielectric multilayer film (A) depending on usage conditions, but not limited thereto. In conditions in which insulating effects in the winter season are emphasized, it is preferred that an infrared absorber-containing layer be disposed close to the outdoor side compared to the dielectric multilayer film (B).

Therefore, most preferably, an infrared absorber is contained in a non-interference layer between the dielectric multilayer film (A) and the dielectric multilayer film (B) or a functional layer, described below, disposed between them, thereby being able to more certainly obtain both heat ray shielding effects in the summer season and insulating effects in the winter season.

Thus, it is thought that an infrared shielding film suitable for annual climatic changes can be actualized by the present invention.

The constituent elements of the infrared shielding film of the present invention and the embodiments for carrying out the present invention and the like will now be described in detail.

### {Infrared Shielding Film}

The infrared shielding film of the present invention indispensably has the function to reflect infrared rays and the function to absorb them. The infrared shielding film of the present invention only needs to include a dielectric multilayer film (A), a dielectric multilayer film (B), a non-interference film disposed between such dielectric multilayer film (A) and such dielectric multilayer film (B), and an infrared absorber as essential components, and further may include a variety of functional layers as required. For example, it is preferred that a functional layer be on the outer side of at least either the dielectric multilayer film (A) or the dielectric multilayer film (B) involved in the present invention. Specific examples of functional layers will be described below and, because the film of the present invention is suitably installed on a window glass and the like and used, can be an adhesive layer and the like to fix the film with the window. In addition, an infrared absorber is contained in any one layer other than the dielectric multilayer film (A) and the dielectric multilayer film (B). Therefore, when functional layers are provided, any of them may contain an infrared absorber.

The constituent examples of the infrared shielding film of the present invention will be described with reference to drawings. The technical scope of the present invention should be determined based on the description of claims and is not limited to the following embodiments. It is noted that the dimensional ratio of the drawings is exaggerated for convenience of description and can be different from the actual ratio.

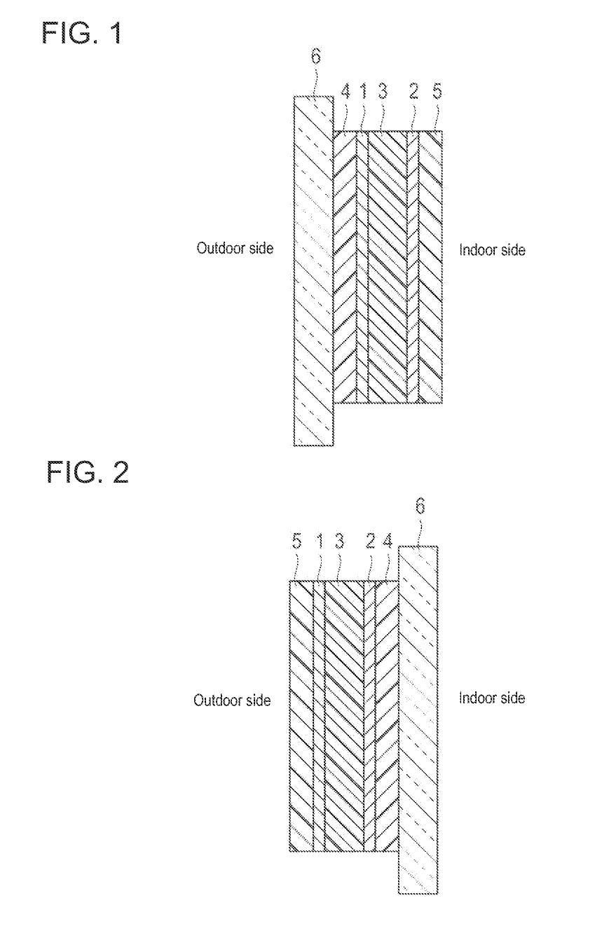

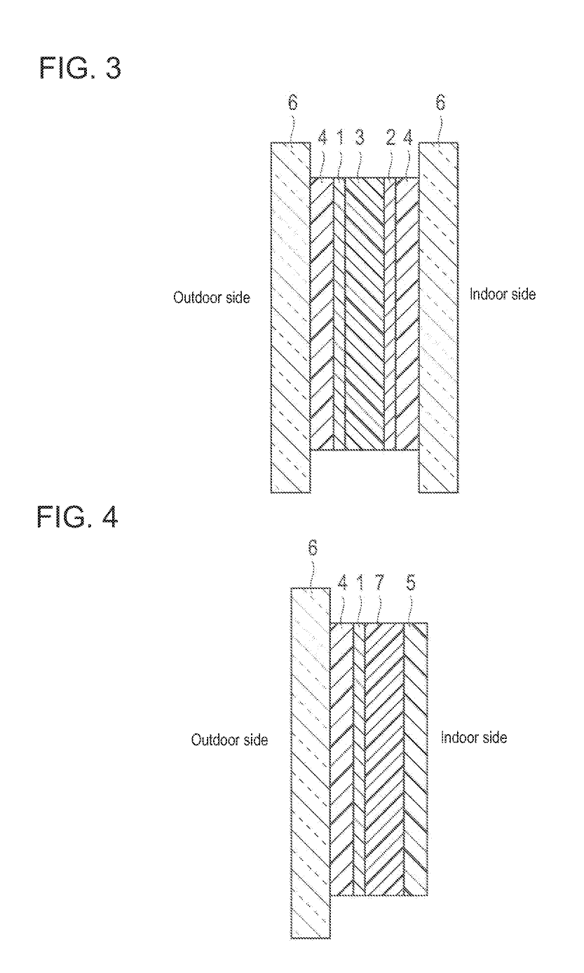

FIG. 1 is a cross-sectional schematic diagram schematically showing an infrared shielding film involved in an embodiment of the present invention. According to FIG. 1, the dielectric multilayer film (A) 1 involved in the present invention is installed on the outdoor side surface of the non-interference layer 3 and the dielectric multilayer film (B) 2 involved in the present invention is installed on the indoor side surface of such non-interference layer 3. In addition, the adhesive layer 4 as a functional layer is installed between such dielectric multilayer film (A) 1 and the window glass 6 and the hard coat layer 5 as a functional layer is installed on the outer surface of such dielectric multilayer film (B) 2. At this time, such infrared shielding film is applied on the indoor side surface of the window glass 6. In addition, according to FIG. 2, the infrared shielding film of the present invention can be applied on the outdoor side surface of the window glass 6, and at this time, the adhesive layer 4 and the hard coat layer 5 as such functional layers are installed on the outer side surface of the dielectric multilayer film (A) 1 and the surface between the dielectric multilayer film (B) 2 and the indoor side, respectively. Further, according to FIG. 3, the infrared shielding film of the present invention can be used for a laminated glass. That is, the dielectric multilayer film (A) 1 involved in the present invention and the adhesive layer 4 as a functional layer are installed in order on the outdoor side surface of the non-interference layer 3, and the dielectric multilayer film (B) 2 involved in the present invention and the adhesive layer 4 as a functional layer are installed in order on the indoor side surface of such non-interference layer 3, and such infrared shielding film can be applied between two window glass plates 6 to be a laminated glass.

The surface on which the above dielectric multilayer film (A) is laminated is preferably installed to face the outdoor side and the film is preferably pasted indoors.

In addition, the dielectric multilayer film (A), non-interference layer and dielectric multilayer film (B) involved in the present invention only need to be laminated in order, and other functional layers can be laminated with the arbitrary number of layers without losing the effect of the present invention.

As the optical characteristics of the infrared shielding film of the present invention, the transmittance in the visible light region shown by JIS R3160-1998 is 40% or more and preferably 60% or more. In addition, the infrared region of the incident spectrum of direct sunlight relates to an increase in room temperature, and, by shielding this, an infrared shielding film can generally suppress the increase in room temperature. When the total energy in the whole infrared region from the shortest infrared wavelength (760 nm) to the longest infrared wavelength (3200 nm) based on weighting coefficients described in Japan Industrial Standard JIS R3106-1998 is considered as 100, about the cumulative energy from 760 nm to each wavelength, the total energy from 760 to 1300 nm accounts for approximately 75% of the whole infrared region. Therefore, shielding this wavelength region is the most efficient for energy saving effects by shielding heat rays in the summer season. In the infrared shielding film of the present invention, the optical film thickness and unit of a dielectric multilayer film are preferably designed so that the dielectric multilayer film (A) will have the maximum reflectance value, which has a reflectance of above 50%, particularly in the near infrared wavelength region of 900 to 1100 nm, and a dielectric multilayer film is more preferably designed to have the maximum reflectance value which has a maximum reflectance of approximately 80% or more in the above region.

Further, by being a reflectance of 50% or more in the wavelength region of 900 to 1100 nm, the large reflection of visible light due to a wavelength shift by the incident angle of light can be prevented. In addition, the range of reflectance usually expands to 760 to 1300 nm, and thus the reflectance is not zero even in the region beyond 900 to 1100 nm. Therefore, near infrared light can be effectively reflected. That is, because, in a dielectric multilayer film, reflection characteristics in which the range of reflectance expands around a wavelength showing the maximum reflectance value are usually shown, when using a dielectric multilayer film showing the maximum reflectance value in the near infrared wavelength region of 900 to 1100 nm, this film shows any level of reflectance over the range of 760 to 1300 nm, which is a cause of an increase in room temperature, and can show a high transmittance in the visible light region.

In addition, in order that mid-far infrared rays emitted by heating in the winter season will be returned to indoors by reflection, it is more further preferred that a dielectric multilayer film be designed to further have the maximum reflectance value in the wavelength region of 1200 to 2100 nm as the dielectric multilayer film (B).

Further, it is preferred that the reflectance of the dielectric multilayer film (B) in the wavelength region of 1200 to 2100 nm be 20 to 50% of the maximum reflectance of the above dielectric multilayer film (A) in the wavelength region of 900 to 1100 nm. That is, in order not to block the incorporation of heat rays from sun into a room in the winter season, a dielectric multilayer film is most preferably designed so that the reflectance of reflection peaks in the wavelength region of 1200 to 2100 nm will be 20 to 50% of the maximum reflectance of reflection peaks in the above wavelength region of 900 to 1100 nm. In addition, the dielectric multilayer film is preferably designed so that the total of wavelength regions having a reflectance of above 20% in the wavelength region of 1200 to 2100 nm will be 300 nm or more.

The total thickness of the infrared shielding film of the present invention is preferably 40 to 1000 μm and more preferably 50 to 500 μm.

Next, each constitution of the infrared shielding film of the present invention will be described in detail.

### <Dielectric Multilayer Film>

In the present invention, the dielectric multilayer film means an infrared shielding film obtained by alternately laminating a layer having low refractive index materials (also referred to as a low refractive index layer) and a layer having high refractive index materials (also referred to as a high refractive index layer).

In order to have the above-mentioned suitable optical characteristics of the infrared shielding film of the present invention, the design of the film thickness of dielectric multilayer films used and the unit in which a high refractive index layer and a low refractive index layer are laminated are required. By obtaining the necessary constitution of dielectric multilayer films by optical simulation (FTG Software Associates Film DESIGN Version 2.23. 3700), it has been found that excellent characteristics are obtained when a high refractive index layer having a refractive index of 1.9 or more and preferably 2.0 or more is used and 6 layers or more are laminated. For example, as the simulation results of a model in which a high refractive index layer and a low refractive index layer (refractive index=1.35) are alternately laminated to 8 layers, when the refractive index of the high refractive index layer is 1.8, the reflectance of a dielectric multilayer film does not reach 70%, but when the refractive index of high refractive index is 1.9, a reflectance of approximately 80% is obtained. In addition, in a model in which a high refractive index layer (refractive index=2.2) and a low refractive index layer (refractive index=1.35) are alternately laminated, when the number of layers laminated is 4, the reflectance of a dielectric multilayer film does not reach even 60%, but when the number of layers laminated is 6, a reflectance of approximately 80% is obtained.

Thus, by changing the constitution of dielectric multilayer films, the target wavelength of light to be reflected can be controlled. Therefore, in the present invention, a desired reflection peak can be actualized by changing the thickness and the number of layers laminated of a high refractive index layer and a low refractive index layer used for each of the dielectric multilayer film (A) and the dielectric multilayer film (B) involved in the present invention. Specifically, when applying the infrared shielding film of the present invention, the dielectric multilayer film (A) involved in the present invention was designed so that near infrared rays from 900 to 1100 nm, in which the strength distribution of solar rays is large, would be efficiently reflected on the outdoor side surface, and the dielectric multilayer film (B) involved in the present invention was designed so that mid-far infrared rays from 1200 to 2100 nm, which it is said that people feel warm, would be reflected on the indoor side surface.

[Dielectric multilayer film (A)]

In the dielectric multilayer film (A) involved in the present invention, the thickness per layer of high refractive index layers used is preferably 50 to 1220 nm and more preferably 70 to 1220 nm. The thickness per layer of low refractive index layers used is preferably 70 to 1350 nm and more preferably 90 to 1330 nm.

In addition, the total film thickness of the dielectric multilayer film (A) involved in the present invention is preferably 1 to 8 μm and more preferably 1.2 to 6 μm.

Further, it is preferred that the total number of layers laminated of high refractive index layers and low refractive index layers constituting the dielectric multilayer film (A) involved in the present invention be 4 layers or more.

### [Dielectric Multilayer Film (B)]

In the dielectric multilayer film (B) involved in the present invention, the thickness per layer of high refractive index layers used is preferably 70 to 1300 nm and more preferably 90 to 1250 nm. The thickness per layer of low refractive index layers used is preferably 80 to 1320 nm and more preferably 90 to 1300 nm.

In addition, the total film thickness of the dielectric multilayer film (B) involved in the present invention is preferably 1 to 8 μm and more preferably 1.2 to 6 μm.

The ratio of the total film thickness of the above dielectric multilayer film (A) and the above dielectric multilayer film (B) is preferably within ±20%.

Herein, the ratio of the total film thickness of the dielectric multilayer film (A) and the dielectric multilayer film (B) involved in the present invention is preferably within ±20% from the viewpoint of concern about warps and more preferably within ±15%. When the ratio of the total film thickness is within the above-mentioned range, a deterioration in application properties due to warps on a window glass and the like can be prevented, and fabricating properties when further forming functional layers on dielectric multilayer films are also excellent. It is noted that a section of the infrared shielding film of the present invention is observed with an electron microscope and SEM and the total film thickness used herein can be calculated based on the following numerical formula (1).

[Math. 1]

Ratio of Total film thickness %=(1−(Total film thickness of Dielectric multilayer film (B)/(Total film thickness of Dielectric multilayer film (A))×100 formula (1)

Further, the number of layers laminated of high refractive index layers and low refractive index layers constituting the dielectric multilayer film (B) involved in the present invention can be the same as or different from the case of the dielectric multilayer film (A) involved in the present invention and is preferably 4 layers or more.

A high refractive index layer and a low refractive index layer constituting the dielectric multilayer film (A) and the dielectric multilayer film (B) involved in the present invention will be now described in detail. It is noted that the refractive index of each layer or differences in the refractive index between the layers, or materials constituting each layer or the amount of materials contained can be the same or different in the case of the dielectric multilayer film (A) and the case of the dielectric multilayer film (B) involved in the present invention.

In addition, in the dielectric multilayer film (A) or dielectric multilayer film (B) involved in the present invention, a layer constitution in which the undermost layer adjoining to the non-interference layer involved in the present invention is a low refractive index layer and the outermost layer is also a low refractive index layer is preferred.

As the dielectric multilayer film (A) or dielectric multilayer film (B) involved in the present invention, a larger difference in the refractive index between a high refractive index layer and a low refractive index layer is preferred from the viewpoint that the infrared reflectance can be increased by a smaller number of stacks. As a difference in the refractive index becomes larger, the number of stacks can be smaller, and thus haze on the infrared shielding film tends to decrease.

In the dielectric multilayer film (A) or dielectric multilayer film (B) involved in the present invention, a refractive index difference Δn between a high refractive index layer and a low refractive index layer adjoining to each other is preferably 0.05 or more and more preferably 0.15 or more. In addition, the upper limit thereof is, but not particularly limited to, desirably 0.65 or less. When Δn is smaller than 0.05, many layers are required to express reflective performance and production steps are increased, which is not desired in terms of costs. In addition, when Δn is greater than 0.65, because a high reflectance can be obtained using a few layers, reflective performance is improved. At the same time, however, higher reflection generated in a wavelength region beyond a wavelength region in which reflection is required also becomes greater, and thus performance irregularities occur. In particular, by film thickness variation, performance changes are increased, which is not desired.

In addition, reflection at the interface of layers adjoining to each other depends on a refractive index ratio between layers, and thus as the refractive index ratio increases, a reflectance becomes higher. In addition, by making a relation in which an optical path difference between reflected light on the surface of the layer and reflected light on the bottom of the layer in a monolayer film is expressed by n·d=wavelength/4, reflected light can be controlled to strengthen each other by a phase difference, and a reflectance can be increased. Herein, n is a reflectance, d is a physical film thickness of a layer, and n·d is an optical film thickness. By using this optical path difference, reflection can be controlled. By setting the central wavelength of reflection, using this relation, the reflection of visible light and infrared light is controlled by controlling the refractive index and film thickness of each film. That is, a reflectance in a specific wavelength region is increased by the refractive index of each layer, the film thickness of each layer and a method for laminating each layer.

The refractive index of the high refractive index layer involved in the present invention is preferably 1.70 to 2.50 and more preferably 1.80 to 2.20. In addition, the refractive index of the low refractive index layer involved in the present invention is preferably 1.10 to 1.60 and more preferably 1.30 to 1.50.

It is preferred that the high refractive index layer and low refractive index layer involved in the present invention contain a metal oxide and a water-soluble polymer.

### [Metal Oxide Particles]

The metal oxides which can be used for the dielectric multilayer film (A) or dielectric multilayer film (B) involved in the present invention are, but are not particularly limited to, preferably transparent dielectric materials. Examples thereof can include titanium oxide, zirconium oxide, zinc oxide, synthetic amorphous silica, colloidal silica, alumina, colloidal alumina, lead titanate, minimum, chrome yellow, zinc yellow, chromium oxide, ferric oxide, iron black, copper oxide, magnesium oxide, magnesium hydroxide, strontium titanate, yttrium oxide, niobium oxide, europium oxide, lanthanum oxide, zircon, tin oxide and the like, and these can be suitably used in combination to adjust refractive indexes in both a low refractive index layer and a high refractive index layer.

Among the above-mentioned materials, the high refractive index materials involved in the present invention preferably include titanium oxide, zirconium oxide, zinc oxide and the like and titanium oxide is more preferably used from the view point of the stability of a composition containing metal oxide particles to form a high refractive index layer. Among these, rutile titanium dioxide with low photocatalytic activity and a high refractive index is particularly preferably used.

As the method for preparing titanium oxide used in the present invention, for example, preparation methods disclosed in JP A S63-17221, JP A H7-819, JP A H9-165218, JP A H11-43327 and the like can be seen as reference.

As the volume average particle diameter of titanium oxide microparticles used in the present invention, the primary particle diameter is preferably 1 to 50 nm and more preferably 4 nm to 30 nm. A volume average particle diameter of 1 nm or more and 50 nm or less is preferred from the viewpoint of less haze and excellent visible light permeability. The method of measuring for the volume average particle diameter of titanium oxide particles involved in the present invention is followed; The particle diameter of any 1000 particles is measured by a method for observing particles themselves with a laser diffraction scattering method, a dynamic light scattering method, or using an electron microscope, or a method for observing particle images appearing on the section and surface of refractive index layers with an electron microscope, and in a group of titanium-based oxide particles in which particles each having a particle diameter of d1, d2 . . . di . . . dk exist in the number of n1, n2 . . . ni . . . nk respectively, when the volume per particle is considered as vi, the volume average particle diameter is the average particle diameter weighed by volume, expressed by volume average particle diameter mv={Σ(vi·di)/{Σ(vi)}.

In the high refractive index layer involved in the present invention, titanium oxide and the above-described metal oxides can be mixed, or a plurality of titanium oxides can be mixed. Among metal oxide particles used in the high refractive index layer involved in the present invention, the preferred amount of titanium oxide contained is 30 to 95% by weight and preferably 70 to 90% by weight with respect to the solid content of a high refractive index layer. The higher amount of titanium oxide contained is preferred from the viewpoint that the refractive index of a high refractive index layer can be increased.

On the other hand, as low refractive index materials involved in the present invention, among the above-mentioned metal oxide particles, silica (silicon dioxide) particles are preferably used. Specific examples thereof include synthetic amorphous silica, colloidal silica and the like. Among these, an acidic colloidal silica sol is particularly preferably used.

The silicon dioxide particles used in the present invention preferably have an average particle diameter of 100 nm or less. The average particle diameter of primary particles of silicon dioxide dispersed in the primary particle state (particle diameter in the state of dispersion liquid before coating) is preferably 20 nm or less and more preferably 10 nm or less. In addition, the average particle diameter of secondary particles is preferably 30 nm or less from the viewpoint of less haze and excellent visible light permeability.

The amount of metal oxide contained in the low refractive index layer involved in the present invention is preferably 30 to 95% by weight and more preferably 60 to 90% by weight with respect to 100% by weight of the solid content of the low refractive index layer. When the amount of a metal oxide as a low refractive index material is 30% by weight or more, the low refractive index layer can have a low refractive index, and when the amount is 95% by weight or less, the flexibility of a low refractive index layer film can be obtained and a dielectric multilayer film can be easily formed.

### [Water-Soluble Polymer]

In the high refractive index layer or low refractive index layer constituting the dielectric multilayer films involved in the present invention, a water-soluble polymer which is used in combination with the above-described metal oxide particles can be contained. For the high refractive index layer and low refractive index layer involved in the present invention, the same water-soluble polymer can be used.

The water-soluble polymers which can be applied to the present invention include gelatin, synthetic polymers such as polyvinyl alcohol, polyvinyl pyrrolidone and polyethylene oxide, inorganic polymers, polysaccharide thickeners and the like, and polyvinyl alcohol and gelatin are particularly preferred in the present invention. These water-soluble polymers can be used alone or two or more of these water-soluble polymers can be used in combination.

The water-soluble polymer involved in the present invention is a polymer compound which is dissolved in an amount of 1% by weight or more and preferably 3% by weight or more in water or a hot water medium.

The amount of water-soluble polymer contained is individually in the range of preferably 30 to 80% by weight and more preferably 30 to 60% by weight with respect to a high refractive index layer or low refractive index layer. When the amount is 30% by weight or more, the transparency of a paint film tends to increase, and when the amount is 80% by weight or less, the high refractive index layer tends to have a higher refractive index and the low refractive index layer tends to have a lower refractive index, which is preferred.

The weight average molecular weight of the water-soluble polymer involved in the present invention is preferably 1,000 or more and 200,000 or less, and further more preferably 3,000 or more and 40,000 or less.

The detail of each water-soluble polymer will now be described.

### (Gelatin)

As the gelatin involved in the present invention, in addition to acid-treated gelatin and alkali-treated gelatin, enzyme-treated gelatin in which enzyme treatment is carried out in the production process of gelatin, and gelatin derivatives, that is, those which have an amino group, an imino group, a hydroxyl group and a carboxyl group as functional groups in the molecules and are treated to reform by reagents having a group which can react therewith can be used.

### (Synthetic Polymer)

Examples of synthetic polymers which can be applied to the present invention include polyvinyl alcohols, polyvinyl pyrrolidones, alkylene oxides, acrylic resin such as polyacrylic acid, an acrylic acid-acrylonitrile copolymer, a potassium acrylate-acrylonitrile copolymer, a vinyl acetate-acrylic acid ester copolymer or an acrylic acid-acrylic acid ester copolymer, styrene acrylic acid resin such as a styrene-acrylic acid copolymer, a styrene-methacrylic acid copolymer, a styrene-methacrylic acid-acrylic acid ester copolymer, a styrene-α-methylstyrene-acrylic acid copolymer or a styrene-α-methylstyrene-acrylic acid-acrylic acid ester copolymer, a styrene-sodium styrene sulfonate copolymer, a styrene-2-hydroxyethyl acrylate copolymer, a styrene-2-hydroxyethyl acrylate-potassium styrene sulfonate copolymer, a styrene-maleic acid copolymer, a styrene-maleic anhydride copolymer, a vinyl naphthalene-acrylic acid copolymer, a vinyl naphthalene-maleic acid copolymer, vinyl acetate copolymers such as a vinyl acetate-maleic acid ester copolymer, a vinyl acetate-crotonic acid copolymer and a vinyl acetate-acrylic acid copolymer and salts thereof. Among these, particularly preferred examples include polyvinyl alcohols and copolymers containing them.

The polyvinyl alcohols preferably used in the present invention include, in addition to usual polyvinyl alcohols obtained by hydrolyzing polyvinyl acetate, modified polyvinyl alcohols such as polyvinyl alcohols in which the end thereof is modified with a cation and anionic modified polyvinyl alcohols having an anionic group can be also included.

As polyvinyl alcohols obtained by hydrolyzing vinyl acetate, those having an average polymerization degree of 1,000 or more are preferably used, and those having an average polymerization degree of 1,500 to 5,000 are particularly preferably used. In addition, those having a saponification degree of 70 to 100% are preferred and those having a saponification degree of 80 to 99.5% are particularly preferred.

Cationic modified polyvinyl alcohols are for example polyvinyl alcohols which have a primary to tertiary amine group and a quaternary ammonium group in the main chain or side chains of the above-mentioned polyvinyl alcohol, as described in JP A S61-10483, and are obtained by saponifying a copolymer of an ethylenically unsaturated monomer having a cationic group and vinyl acetate.

Examples of ethylenically unsaturated monomers having a cationic group include trimethyl-(2-acrylamide-2,2-dimethylethyl) ammonium chloride, trimethyl-(3-acrylamide-3,3-dimethylpropyl) ammonium chloride, N-vinylimidazole, N-vinyl-2-methylimidazole, N-(3-dimethylaminopropyl)methacrylamide, hydroxylethyl trimethyl ammonium chloride, trimethyl-(2-methacrylamidopropyl)ammonium chloride, N-(1,1-dimethyl-3-dimethylaminopropyl) acrylamide and the like. The proportion of cationic modified group-containing monomer to vinyl acetate in a cationic modified polyvinyl alcohol is 0.1 to 10 mol % and preferably 0.2 to 5 mol %.

Examples of anionic modified polyvinyl alcohols include polyvinyl alcohols having an anionic group as described in JP A H1-206088, copolymers of vinyl alcohol and a vinyl compound having a water-soluble group as described in JP A S61-237681 and JP A S63-307979, and modified polyvinyl alcohols having a water-soluble group as described in JP A H7-285265.

In addition, examples of nonionic modified polyvinyl alcohols include polyvinyl alcohol derivatives in which a polyalkylene oxide group is added to a part of vinyl alcohol as described in JP A H7-9758, block copolymers of a vinyl compound having a hydrophobic group and vinyl alcohol described in JP A H8-25795, and the like. Two or more polyvinyl alcohols with different polymerization degrees and modification types can be also used in combination.

In the present invention, when these polymers are used, a curing agent can be used. When a polyvinyl alcohol is used, for example, boric acid and salts thereof and epoxy-based curing agents described below are preferred.

### [Additives]

A variety of additives which can be applied to the high refractive index layer and low refractive index layer involved in the present invention are enumerated below.

### (Curing Agent)

In the present invention, it is preferred that a curing agent be used to cure a water-soluble polymer, which is a binder.

The curing agent which can be applied to the present invention is not particularly limited as long as curing reaction with a water-soluble polymer occurs, and when the water-soluble polymer is the above-described polyvinyl alcohol, preferred are boric acid and salts thereof. In addition to these, known curing agents can be also used and are generally compounds having a group which can be reacted with a water-soluble polymer or compounds which promote the reaction of different groups in a water-soluble polymer. The curing agent is suitably selected depending on the types of water-soluble polymer and used. Specific examples of curing agents, for example, include epoxy-based curing agents (such as diglycidyl ethyl ether, ethylene glycol diglycidyl ether, 1,4-butanediol diglycidyl ether, 1,6-diglycidyl cyclohexane, N,N-diglycidyl-4-glycidyloxy aniline, sorbitol polyglycidyl ether and glycerol polyglycidyl ether), aldehyde-based curing agents (such as formaldehyde and glyoxal), active halogen-based curing agents (such as 2,4-dichloro-4-hydroxy-1,3,5-s-triazine), active vinyl-based compounds (such as 1,3,5-trisacryloyl-hexahydro-s-triazine and bisvinylsulfonylmethyl ether), aluminum alum and the like.

In addition, when a water-soluble polymer is gelatin, examples thereof can include organic hardening agents such as vinyl sulfone compounds, urea-formaldehyde condensates, melanin-formaldehyde condensates, epoxy compounds, aziridine compounds, active olefins and isocyanate compounds, inorganic polyvalent metal salts such as chromium, aluminum and zirconium, and the like.

The total amount of the above curing agent used varies depending on the type of water-soluble polymer, and is preferably 1 to 600 mg per g of water-soluble polymer and more preferably 100 to 600 mg.

### (Surfactant Agent)

To at least one layer of the high refractive index layer and low refractive index layer involved in the present invention, a surfactant agent can be added. As the type of active agent, any type of anionic, cationic and nonionic surfactant agents can be used. Particularly preferred are acetylene glycol-based nonionic surfactant agents, quaternary ammonium-based cationic surfactant agents and fluorine-based cationic surfactant agents.

The amount of the surfactant agent involved in the present invention added is, when each coating liquid is 10% by weight, preferably in the range of 0.005 to 0.30% by weight as the solid content and further preferably 0.01 to 0.10% by weight.

In addition to the above-described additives, in the high refractive index layer and low refractive index layer involved in the present invention, for example, a variety of known additives can be also contained, such as ultraviolet absorbers, pH adjustors such as sulfuric acid, phosphoric acid, acetic acid, citric acid, sodium hydroxide, potassium hydroxide and potassium carbonate, anti-foaming agents, lubricants such as diethylene glycol, preservative agents, antistatic agents and matting agents, described in JP A S57-74193, JP A S57-87988 and JP A S62-261476.

### <Non-Interference Layer>

In the non-interference layer involved in the present invention, any layer can be laminated between the dielectric multilayer film (A) involved in the present invention and such non-interference layer and any layer can be laminated between the dielectric multilayer film (B) involved in the present invention and such non-interference layer. It is essential, however, that the non-interference layer involved in the present invention is disposed between the dielectric multilayer film (A) and the dielectric multilayer film (B) in order that the optical characteristics generated from the dielectric multilayer film (A) and the dielectric multilayer film (B) will not interfere with each other.

To achieve the objects of the present invention, using the dielectric multilayer film (A) and the dielectric multilayer film (B), the present invention is designed to reflect infrared light rays in different wavelength regions. In general, it is known that light has coherence length and interference does not occur when an optical path difference is sufficiently long compared to the coherence length. The coherence length of infrared light is said to be short, which is approximately a few microns. That is, in order that reflected light generated in the dielectric multilayer film (A) involved in the present invention and reflected light generated in the dielectric multilayer film (B) involved in the present invention will not interfere, an optical path difference only needs to be greater than a few microns. Therefore, the thickness of the non-interference layer involved in the present invention is 5 μm or more. The upper limit of the thickness is not particularly decided from the viewpoint of optical performance, and is 500 μm or less because of flexibility as a film and more preferably 100 μm or less.

In the non-interference layer involved in the present invention, the transmittance in the visible light region shown by JIS R3106-1998 is preferably 85% or more and more preferably 90% or more. When the transmittance of visible light is 85% or more, it is advantageous in that, when producing the infrared shielding film of the present invention, a transmittance of 40% or more and preferably 60% or more in the visible light region shown by JIS R3106-1998 is obtained.

The non-interference layer involved in the present invention can be formed using transparent materials, and the materials are not particularly limited as long as there is a function to prevent the interaction between reflected lights from the dielectric multilayer film (A) and dielectric multilayer film (B) involved in the present invention. The constitution obtained by mixing and laminating one or two or more materials can be used.

Examples of transparent materials which can be applied to the non-interference layer involved in the present invention can include resin films such as methacrylic acid ester, polyethylene terephthalate (PET), polyethylene naphthalate (PEN), polycarbonate (PC), polyarylate, polystyrene (PS), aromatic polyamide, polyetherether ketone, polysulfone, polyethersulfone, polyimide and polyetherimide, and further resin films obtained by laminating two or more layers of the above resins, and the like. In addition, the materials described in the above-described water-soluble polymer section can be also preferably used.

The non-interference layer involved in the present invention can be coated simultaneously with the production of the dielectric multilayer film (A) and dielectric multilayer film (B) involved in the present invention, and the layer separately produced by e.g. extrusion molding can be pasted thereon.

Further, the non-interference layer involved in the present invention can contain an infrared absorber described below and can be also used as a functional layer.

### <Functional Layer>

In the present invention, it is preferred that a functional layer be on the outer side of at least one of the above dielectric multilayer film (A) or the above dielectric multilayer film (B).

The infrared shielding film of the present invention can have one or more functional layers such as a conductive layer, an antistatic layer, a gas barrier layer, an easily adhesive layer (bonding layer), an antifouling layer, a deodorant layer, a droplet flowing layer, a slippery layer, an abrasion resistant layer, a hard coat layer, an antireflection layer, an electromagnetic shielding layer, an ultraviolet absorbing layer, a printed layer, a fluorescent emission layer, a hologram layer, a release layer, an adhesive layer, a bonding layer, infrared cut layers other than the high refractive index layer and the low refractive index layer of the present invention (a metal layer, a liquid crystal layer), a colored layer (a visible light absorbing layer) and an intermediate film layer used for a laminated glass for the purpose of adding further functions, and these functional layers can be used as the non-interference layer of the present invention. In addition, it is preferred that a functional layer be on the outer side of at least one of the dielectric multilayer film (A) and dielectric multilayer film (B) involved in the present invention. As shown in FIG. 1 described above, for example, when the infrared film of the present invention is applied on the indoor side of a window glass, an adhesive layer is preferably on the outer side of the corresponding dielectric multilayer film (A) from the viewpoint of easily bonding application to a window glass. A hard coat layer is preferably on the outer side of the corresponding dielectric multilayer film (B) from the viewpoint of surface protection to increase abrasion resistance.

An adhesive layer and a hard coat layer, which are preferred functional layers, will be described in order.

### [Adhesive Layer]

An adhesive layer can be provided to either outermost surface of the infrared shielding film of the present invention.

As an adhesive constituting the adhesive layer involved in the present invention, for example, an acrylic adhesive, a silicon adhesive, a urethane adhesive, a polyvinyl butyral adhesive, an ethylene-vinyl acetate adhesive and the like can be exemplified.

When the infrared shielding film of the present invention is pasted to a window glass, a method by, after spraying water to the window, pasting an adhesive layer of the infrared shielding film to a glass surface in the wet state, that is, the so-called water bonding method is appropriately used from the viewpoint of repasting, repositioning and the like. Therefore, an acrylic adhesive with low adhesive strength under infiltration conditions in which water exists is preferably used.

The acrylic adhesives used can be of a solvent type or an emulsion type, and are preferably adhesives of a solvent type because adhesive strength and the like are easily increased. Among these, those which are obtained by solution polymerization are preferred.

In this adhesive layer, for example, a stabilizer, a surfactant agent, an ultraviolet absorber, a flame retarder, an antistatic agent, an antioxidant, a heat stabilizer, a lubricant agent, a filler, coloration, a bonding adjustor and the like can be also contained as additives. In particular, for the use for pasting on a window as in the present invention, the addition of an ultraviolet absorber is effective to suppress the deterioration of an infrared shielding film due to ultraviolet rays.

The thickness of the adhesive layer involved in the present invention is preferably 1 μm to 100 μm and more preferably 3 to 50 μm. When the thickness is 1 μm or more, adhesiveness tends to improve and sufficient adhesive strength is obtained. Contrarily, when the thickness is 100 μm or less, not only the transparency of the infrared shielding film is improved but also, when a film is pasted on a window glass and then peeled off, a cohesive failure does not occur between the glass and an adhesive layer and adhesive materials tends not to remain on the glass surface.

An infrared absorber described below can be also contained in the adhesive layer involved in the present invention.

### [Hard Coat Layer]

The hard coat layer involved in the present invention can be laminated on the both sides of the infrared shielding film of the present invention or can be laminated on one side thereof.

As curable resins used for the hard coat layer involved in the present invention, thermosetting resins and ultraviolet curable resins can be used, and ultraviolet curable resins are preferred from the viewpoint of ease of molding. Among these, those having a pencil hardness of at least 2H are more preferred. Such curable resins can be used alone or two or more of the resins can be used in combination.

Examples of such ultraviolet curable resins can include multifunctional acrylate resins such as an acrylic acid or methacrylic acid ester having polyhydric alcohol, as well as multifunctional urethane acrylate resins as synthesized from diisocyanate and acrylic acid or methacrylic acid having polyhydric alcohol, and the like. Further, polyether resins and polyester resins having an acrylate functional group, epoxy resins, alkyd resins, spiro acetal resins, polybutadiene resins, polythiol polyene resins or the like can be also suitably used.

In addition, photosensitizers (radical polymerization initiator) can be contained in these resins. The amount of these radical polymerization initiators used is 0.5 to 20 parts by weight and preferably 1 to 15 parts by weight with respect to 100 parts by weight of polymerizable component of a resin.

It is noted that the above-described curable resins can be combined with known general coating additives as required. Silicone-based and fluorine-based additives imparting levelling and surface slipping properties and the like, for example, have the effect of preventing flaws on the surface of a cured film, as well as, when ultraviolet rays as active energy rays are used, can reduce the inhibition of resin curing by oxygen by bleeding of the above additives to the air interface, and an effective curing degree can be obtained even under the condition of low radiation intensity.

In addition, the hard coat layer preferably contains inorganic microparticles. As preferred inorganic microparticles, microparticles of an inorganic compound including a metal such as titanium, silica, zirconium, aluminum, magnesium, antimony, zinc or tin can be used. The average particle diameter of the inorganic microparticles is preferably 1000 nm or less and more preferably in the range of 10 to 500 nm to secure the permeability of visible light rays. In addition, when bonding strength with a curable resin forming a hard coat layer is higher, the falling off of inorganic microparticles from the hard coat layer can be suppressed, and thus those in which a photosensitive group having photopolymerization reactivity such as monofunctional or multifunctional acrylate is introduced on the surface thereof are preferred.

The thickness of the hard coat layer is preferably 0.1 μm to 50 μm and more preferably 1 to 20 μm. When the thickness is 0.1 μm or more, hard coat properties tend to improve. Contrarily, when the thickness is 50 μm or less, the transparency of an infrared shielding film tends to improve.

It is noted that an infrared absorber described below can be contained in the hard coat layer.

The method for forming a hard coat layer is not particularly limited, and examples thereof include a method for forming a hard coat layer by, after preparing a coating liquid for a hard coat layer including the above-mentioned components, coating the coating liquid with a wire bar and the like and curing the coating liquid with heat and/or UV, and the like.

### <Infrared Absorber>

In the infrared shielding film of the present invention, an infrared absorber is contained in any one layer other than the dielectric multilayer film (A) and dielectric multilayer film (B) involved in the present invention.

In addition, the above infrared absorber is preferably contained in a layer between the above dielectric multilayer film (A) and the above dielectric multilayer film (B). That is, more preferably a layer between the dielectric multilayer film (A) and the dielectric multilayer film (B) involved in the present invention includes infrared absorber. Further, by containing an infrared absorber in the non-interference layer involved in the present invention, among incident infrared rays in the dielectric multilayer film (A) or (B), remaining infrared rays which are not reflected penetrate the layer containing the infrared absorber. Thus, the amount of infrared rays absorbed in the whole film can be decreased and temperature increase can be reduced and accordingly this is most preferred. By combining an infrared absorber, infrared rays which cannot be reflected on the dielectric multilayer film (A) or (B) can be shielded, and thus the infrared ray shielding effect in the wider wavelength range can be obtained as an infrared shielding film. Further, according to the present invention, a dielectric multilayer film (A) having a reflectance in the near infrared region equal to or greater than a specific value is used, and thus even when an infrared absorber is combined for an infrared shielding film, the risk of heat cracks is very low. When aiming to actualize an infrared shielding film only by reflection on dielectric multilayer films, because the reflection band region of a dielectric multilayer film is usually narrow compared to the infrared ray region, a device to broaden the band region by laminating a plurality of units in which the film thickness and the like of dielectric multilayer films are gradually shifted is required. Therefore, the production steps are increased and become complicated and the costs also increase. Thus, in the present invention, an infrared absorber is combined.

The infrared absorber used in the present invention is not particularly limited as long as it is an infrared absorber which is generally added to a transparent resin and used. The infrared absorber is preferably a compound in which, about a solution obtained by dissolving 0.1 parts by weight of compound in 100 parts by weight of good solvent, the light ray transmittance is 50% or less and further 30% or less in a part or the whole of near infrared ray wavelength region of 600 to 2500 nm using the above good solvent as a control. Examples of such infrared absorbers include infrared absorbers disclosed in JP A H6-200113, such as cyan-based near infrared absorbers, pyrylium-based near infrared absorbers, squarylium-based near infrared absorbers, croconium-based near infrared absorbers, azulenium-based near infrared absorbers, phthalocyanine-based near infrared absorbers, dithiol metal complex-based near infrared absorbers, naphthoquinone-based near infrared absorbers, anthraquinone-based near infrared absorbers, indophenol-based near infrared absorbers and azide-based near infrared absorbers. In addition, commercially available infrared ray absorbers can be also used, such as SIR-103, SIR-114, SIR-128, SIR-130, SIR-132, SIR-152, SIR-159, SIR-162 (all manufactured by Mitsui Toatsu Dyes, Ltd.), Kayasorb IR-750, Kayasorb IRG-002, Kayasor IRG-003, IR-820B, Kayasorb IRG-022, Kayasorb IRG-023, Kayasorb CY-2, Kayasorb cCY-4, Kayasorb CY-9 (all manufactured by Nippon Kayaku Co., Ltd.).

In addition, as infrared absorbers other than the above, inorganic infrared absorbers such as indium tin oxide (ITO), antimony tin oxide (ATO), zinc antimonate, lanthanum hexaboride (LaB₆) and cesium tungsten oxide (Cs_{0.33}WO₃) can be also used. These can be used alone or two or more of these can be used in combination.

The amount of infrared absorber used in the present invention contained in a corresponding layer depends on an extinction coefficient which is changed depending on the types, particle diameter and the like of infrared ray absorbers, and thus the amount added can be suitably controlled as required.

In the case of antimony tin oxide (ATO) put on the market for heat shielding, for example, preferred is 3 g/m² or more.

### {Method for Producing Infrared Shielding Film}

The method for producing the infrared shielding film of the present invention is not particularly limited and any method can be used as long as the dielectric multilayer film (A) obtained by alternately laminating a high refractive index layer and a low refractive index layer and the dielectric multilayer film (B) obtained by alternately laminating a high refractive index layer and a low refractive index layer can be each formed on both sides of a non-interference layer.

The following methods, for example, are mentioned; method (1) by which first, the non-interference layer involved in the present invention is molded using non-interference layer materials, either the dielectric multilayer film (A) or dielectric multilayer film (B) obtained by alternately laminating a high refractive index layer and a low refractive index layer is then coated thereon and dried, another dielectric multilayer film is then coated on the back side surface of such non-interference layer and dried, and on each surface, other functional layers are further coated as required to produce an infrared shielding film; method (2) by which the dielectric multilayer films (A) and (B) are simultaneously coated on both sides of the molded non-interference layer and dried, and on each surface, other functional layers are further coated as required to produce an infrared shielding film; method (3) by which on the base, either the dielectric multilayer film (A) or (B) is coated and dried, and a non-interference layer and another one of the above dielectric multilayer film (A) or (B) are coated thereon and dried to produce an infrared shielding film; and the like. In the methods, when the dielectric multilayer film (A) or (B) is formed, specifically, it is preferred that a laminated product be formed by alternately carrying out by wet coating of a water-based high refractive index layer forming coating liquid and low refractive index layer forming coating liquid and drying. The method of simultaneous multilayer coating of a high refractive index layer forming coating liquid and a low refractive index layer forming coating liquid is an easier process, which is more preferred.

As coating methods, for example, a roll coating method, a rod bar coating method, an air knife coating method, a spray coating method, a curtain coating method, a slide bead coating method using a hopper described in U.S. Pat. No. 2,761,419 and U.S. Pat. No. 2,761,791, an extrusion coating method or the like is preferably used.

As the base used in the above-mentioned method (3) for producing an infrared shielding film, various resin films can be used. Polyolefin films (such as polyethylene and polypropylene), polyester films (such as polyethylene terephthalate and polyethylene naphthalate), polyvinyl chloride, cellulose triacetate and the like can be used, and polyester films are preferred.

The thickness of the base used in the present invention is 10 to 300 μm and particularly preferably 20 to 150 μm. In addition, as the base of the present invention, two bases laminated can be used, and in this case, the types thereof can be the same or different. In addition, a base can be inserted between the above-described non-interference layer and the dielectric multilayer film (A) or (B).

The solvent to prepare a high refractive index layer forming coating liquid and a low refractive index layer forming coating liquid is not particularly limited and is preferably water, an organic solvent or a mixed solvent thereof. In particular, the solvent of coating liquids is preferably water, or a mixed solvent of water and methanol, ethanol or ethyl acetate in terms of environments and ease of operation and more preferably water.

The concentration of water-soluble polymer in a high refractive index layer forming coating liquid is preferably 1 to 10% by weight. In addition, the concentration of metal oxide particles in a high refractive index layer forming coating liquid is preferably 1 to 50% by weight.

The concentration of water-soluble polymer in a low refractive index layer forming coating liquid is preferably 1 to 10% by weight. In addition, the concentration of metal oxide particles in a low refractive index layer forming coating liquid is preferably 1 to 50% by weight.

When currying out simultaneous multilayer coating, the viscosity of a high refractive index layer forming coating liquid and a low refractive index layer forming coating liquid is preferably in the range of 5 to 100 mPa·s and further preferably the range of 10 to 50 mPa·s when using a slide bead coating method. In addition, when using a curtain coating method, the viscosity is preferably in the range of 5 to 1200 mPa·s and further preferably in the range of 25 to 500 mPa·s.

As coating and drying methods, preferably, a water-based high refractive index layer forming coating liquid and low refractive index layer forming coating liquid are heated to 30° C. or more and coated, and the formed paint film is then once cooled to 1 to 15° C. and dried at 10° C. or more. More preferably, as drying conditions, drying is carried out under the conditions of a wet-bulb temperature of 5 to 50° C. and a film surface temperature of 10 to 50° C. In addition, as a cooling method immediately after coating, a horizontal set method is preferred from the viewpoint of the uniformity of the formed paint film.

As a method for applying adhesives, any known methods can be used. These can be appropriately applied by obtaining a solution using a solvent which can dissolve an adhesive or using a coating liquid in which an adhesive is dispersed. As the solvent, known solvents can be used.

As the formation of the adhesive layer involved in the present invention, an adhesive layer can be directly applied to the infrared shielding film of the present invention. In addition, an adhesive layer is once applied to a release film and dried, and the infrared shielding film of the present invention is then pasted thereon and the adhesive can be transferred.

The method for forming other functional layers such as the hard coat layer involved in the present invention is not particularly limited and any known methods can be used.

As a curing method by ultraviolet radiation, curing can be carried out by irradiating ultraviolet rays in the wavelength region of 100 to 400 nm emitted from a super-high pressure mercury lamp, a high pressure mercury lamp, a low pressure mercury lamp, a carbon arc, a metal halide lamp or the like, or irradiating electron beams in the wavelength region of 100 nm or less emitted from a scanning or curtain electron linear accelerator.

### {Infrared Shield}

The infrared shield of the present invention indicates a mode in which the infrared shielding film of the present invention is provided to at least one side of a substrate.

Preferred substrates are preferably a plastic substrate, a metal substrate, a ceramic substrate, a fabric substrate and the like, and the infrared shielding film of the present invention is provided to a substrate in various forms such as film, plate, sphere, cube and cuboid. Among these, a ceramic substrate in the form of plate is preferred, and an infrared shield in which the infrared shielding film of the present invention is provided to a glass plate is preferred. Examples of glass plates are preferably, for example, a float plate glass described in JIS R3202, and a polished plate glass, and the glass thickness is preferably 0.01 mm to 20 mm. Herein, when a substrate is for example a building window glass or the front glass of a car, an infrared shielding film can be pasted on the substrate provided to the main body (a window frame etc.). In this case, the film can be pasted close to the outdoor side compared to the substrate or can be pasted close to the indoor side compared to the substrate. Further, an infrared shielding film is pasted on a substrate (e.g. glass) to be provided to a window and the like in advance to form a shield, and the shield can be installed in the main body as a building window glass or a glass of a car. Also in this case, the dielectric multilayer film (A) is installed to face outdoors, but the infrared shielding film can be desposed on either the indoor side or outdoor side. It is better to dispose an infrared shielding film on the indoor side from the viewpoint of durability and from the viewpoint of indoor heat retaining properties.

As a method for providing the infrared shielding film of the present invention to a substrate, a method in which an adhesive layer is painted on an infrared shielding film and the film is pasted on a substrate via the adhesive layer as described above is suitably used.

As a method for lamination, dry lamination by which a film is directly pasted on a substrate, and a method of wet lamination as described above can be adapted, and in order that air will not enter between a substrate and an infrared shielding film, lamination by a wet lamination method is more preferred from the viewpoint of ease of application such as positioning of an infrared shielding film on the substrate.

When bending and warps exist in an infrared shielding film itself, lamination is difficult and simultaneously exfoliation after lamination easily occurs. Therefore, it is desired that an infrared shielding film be produced to suppress bending and warps to the utmost. In order to reduce film stress, it is preferred that the ratio of the film thickness of the dielectric multilayer film (A) and the dielectric multilayer film (B) be 20% or less and more preferably 15% or less. In the dielectric multilayer films (A) and (B), the difference of coefficients of linear expansion from each other can cause bending and warps; however, when the film thickness ratio is within the above-mentioned range, bending and warps can be effectively prevented.

The infrared shield of the present invention can be in a state in which the infrared shielding films of the present invention are provided to several surfaces of a substrate and a state in which several substrates are provided to the infrared shielding film of the present invention. The infrared shield of the present invention, for example, can be a mode in which the infrared shielding films of the present invention are provided to both sides of the above-described plate glass, and a mode of a laminated glass in which adhesive layers are painted on both sides of the infrared shielding film of the present invention and the above-described plate glasses are pasted on both sides of the infrared shielding film.

In both cases, the dielectric multilayer film (A) reflecting near infrared rays is installed to face the outdoor side and the dielectric multilayer film (B) reflecting mid-far infrared rays is installed to face the indoor side.

### {Application of Infrared Shielding Film}

The infrared shielding film of the present invention can be applied in a wide range of fields, and is used, for example, as a window film, to which the infrared-reflecting effect to suppress an excessive increase in room temperature is imparted by pasting on a window exposed to the sun light, such as a building outdoor window or a car window, or a film for an agricultural vinyl house or the like, and mainly used as an agricultural film to which the infrared shielding effect to suppress an excessive increase in temperature inside a house is imparted.

Like a laminated glass for cars, the infrared shielding film of the present invention is inserted between a glass and a glass and used as an infrared shielding film for cars. In this case, the infrared shielding film can be blocked from the outside gas, which is preferred from the viewpoint of durability.

As a preferred embodiment, the present invention also provides a window frame body which has a glass provided with the infrared shielding film of the present invention, in which the surface on which the dielectric multilayer film (A) is laminated is installed to face the outdoor side.

As still another embodiment, the present invention also provides a method for installing a window frame body which has a glass provided with the infrared shielding film of the present invention, in which the surface on which the dielectric multilayer film (A) is laminated is installed to face the outdoor side. By applying the window frame body of the present invention to windows of a building such as a house or the method for installing a window frame body of the present invention, an increase in room temperature can be suppressed in the summer season and room temperature can be maintained in the winter season. Thus, comfortable room environment can be maintained with reduced energy.

### EXAMPLES

The present invention will now be described in detail by way of examples thereof. It is noted, however, that the present invention is not limited thereto. In the examples, the expression of “parts” or “%” is used. Unless otherwise specified, it represents “parts by weight” or “% by weight”.

### Example 1

### Preparation of Low Refractive Index Layer Forming Coating Liquid

To 500 parts by weight of pure water, 15.0 parts by weight of partially saponified polyvinyl alcohol (water-soluble resin JP45 (manufactured by JAPAN VAM & POVAL CO., LTD., saponification degree 88%, polymerization degree 4500)) was added while stirring, and the obtained mixture was then heated to 70° C. and dissolved while mixing 2.0 parts by weight of modified polyvinyl alcohol (water-soluble resin AZF8035 (manufactured by The Nippon Synthetic Chemical Industry Co., Ltd.)) to obtain an aqueous solution of the water-soluble resin.

Next, the total amount of the aqueous solution of the water-soluble resin obtained above was added to 350 parts by weight of a 10% by weight acidic silica sol containing silica microparticles with an average particle diameter of 5 nm (SNOWTEX OXS, manufactured by Nissan Chemical Industries, Ltd.) and mixed. Further, 10 parts by weight of a 4% by weight aqueous solution of boric acid were added thereto and the obtained mixture was stirred for an hour and then increased to 1000.0 g with pure water to prepare a low refractive index layer forming coating liquid L1.

### [Preparation of High Refractive Index Layer Forming Coating Liquid]

### [Preparation of Water-Based Titanium Dioxide Sol Dispersion Liquid]

First, sodium silicate No. 4 (manufactured by Nippon Chemical Industrial Co., LTD.) was diluted with pure water so that the concentration, which is converted into SiO₂, would be 2.0% by weight to prepare an aqueous solution of silicic acid.

Thereafter, to 0.5 kg of a 15.0% by weight titanium oxide sol (volume average particle diameter 5 nm, rutile titanium dioxide particles (manufactured by Sakai Chemical Industry Co., Ltd.: Product name SRD-W)), 2 kg of pure water was added and the obtained mixture was then heated to 90° C. Next, 1.3 kg of the above-mentioned prepared aqueous solution of silicic acid was gradually added thereto. The obtained mixture was subjected to heating treatment at 175° C. for 18 hours in an autoclave, and cooled and then concentrated with an ultrafiltration membrane to obtain a titanium oxide sol, whose surface is coated with SiO₂ (hereinafter, referred to as “silica-coated titanium oxide sol”, solid content concentration: 20% by weight).

With 28.9 parts of the above obtained silica-coated titanium oxide sol water-based dispersion liquid with a solid content concentration of 20.0% by weight, 9.0 parts of a 4% by weight aqueous solution of boric acid were mixed to prepare a dispersion liquid of silica modified titanium oxide particles H1.

Next, while stirring the dispersion liquid of silica modified titanium oxide particles H1, 16.3 parts of pure water and 33.5 parts of a 5.0% by weight aqueous solution of polyvinyl alcohol (RS2117, manufactured by KURARAY CO., LTD.) were added thereto. Ultimately, the obtained mixture was increased to 1000 parts with pure water to prepare a high refractive index layer forming coating liquid H1.

The refractive indexes of the high refractive index layer and low refractive index layer produced by the above-described method were measured, and were 1.9 and 1.45, respectively.

### [Formation of Non-Interference Layer]

To 100 parts by weight of thermoplastic saturated norbornene resin (ZEONEX 280, manufactured by Zeon Corporation, glass transition temperature approx. 140° C., number average molecular weight approx. 28,000), 1 part by weight of near infrared ray absorber SIR-128 (manufactured by Mitsui Toatsu Dyes, Ltd., absorption wavelength region of approx. 700 to approx. 1000 nm) was added with a biaxial extrusion kneader with a diameter of 35 mm (TEM-35B, manufactured by TOSHIBA MACHINE CO., LTD.) and the obtained mixture was kneaded at a resin temperature of 220° C. and pelletized with a pelletizer. This pellet was molded at a resin temperature of 260° C. to form an infrared absorber-containing non-interference layer N1.

### [Formation of Adhesive Layer]

60 parts by weight of ethyl acetate and 20 parts by weight of toluene were mixed, and further 20 parts by weight of acrylic adhesive (ARONTACK M-300, manufactured by TOAGOSEI CO., LTD.) were added thereto with stirring and mixed to obtain an adhesive coating liquid.

As a separator film, a polyester film with a thickness of 25 μm (Cerapeel: manufactured by Toyo Metallizing Co., Ltd.) was used. On this separator film, the adhesive coating liquid was coated with a wire bar and dried at 80° C. for 2 minutes to produce a film with an adhesive layer. The adhesive layer surface of this film was laminated in a fixed position using a laminating machine. At this time, the tension during lamination on the infrared shielding film side was 10 kg/m and the tension during lamination of the film with the adhesive layer was 30 kg/m.

### [Formation of Hard Coat Layer]

To 90 parts by weight of methylethyl ketone solvent, 7.5 parts by weight of UV-curable hard coat material (UV-7600B: manufactured by Nippon Synthetic Chemical Industry Co., Ltd.) were added, and to the obtained mixture, 0.5 parts by weight of photopolymerization initiator (IRGACURE 184: manufactured by Ciba Specialty Chemicals) were then added with stirring and mixed to obtain a hard coat layer forming coating liquid.

Next, a hard coat layer coating liquid was coated in a fixed position with a wire bar and dried with hot air at 70° C. for 3 minutes. After that, curing was carried out in the atmosphere under curing conditions of 400 mJ/cm² using a UV curing device (using a high pressure mercury lamp) manufactured by EYE GRAPHICS Co., Ltd. to form a hard coat layer.

### [Production of Infrared Shielding Film 1]

Using a slide hopper coating device by which simultaneous multilayer coating can be carried out, with the temperature maintained at 45° C., simultaneous multilayer coating was carried out on the infrared absorber-containing non-interference layer N1 produced above using the above-mentioned prepared low refractive index layer forming coating liquid and high refractive index layer forming coating liquid. At this time, in the layer constitution, a low refractive index layer was on the film surface side, and 7 low refractive index layers and 6 high refractive index layers, a total of 13 layers, were each alternately laminated. Immediately after that, the obtained laminated product was set by blowing cool air for a minute under conditions in which the film surface becomes 15° C. or less and then dried by blowing 80° C. hot air to produce a dielectric multilayer film (A1).

Subsequently, 5 low refractive index layers and 4 high refractive index layers, a total of 9 layers, were coated on another surface of the above-mentioned film, and set and dried to produce a dielectric multilayer film (B1) in the same manner as above.

Next, an adhesive layer was formed on the dielectric multilayer film (A1) so that the film thickness would be 10 μm and a hard coat layer was formed on the dielectric multilayer film (B1) so that the film thickness would be 10 μm by the above-described method to obtain an infrared shielding film 1. The dielectric multilayer film (A1) corresponds to the dielectric multilayer film (A) of the present invention and the dielectric multilayer film (B1) corresponds to the dielectric multilayer film (B) of the present invention.

When the section of the painted film was observed by SEM, the film thicknesses (except a thick film layer) of low refractive index layers and high refractive index layers of the dielectric multilayer film (A1) were 147 to 325 nm and 113 to 130 nm, respectively, and the total film thickness was 2.39 μm. In addition, the film thicknesses (except a thick film layer) of low refractive index layers and high refractive index layers of the dielectric multilayer film (B1) were 90 to 290 nm and 192 to 237 nm, respectively, and the total film thickness was 2.30 μm. It is noted that the film thickness of each high refractive index layer and low refractive index layer is shown in Table 1.

### Example 2

Using a slide hopper coating device by which simultaneous multilayer coating can be carried out, with the temperature maintained at 45° C., simultaneous multilayer coating was carried out on a polyethylene terephthalate (PET) base with a thickness of 50 μm using the above-mentioned prepared low refractive index layer forming coating liquid and high refractive index layer forming coating liquid. At this time, in the layer constitution, a low refractive index layer was on the film surface side, and 4 low refractive index layers and 3 high refractive index layers, a total of 7 layers, were each alternately laminated. Immediately after that, the obtained laminated product was set by blowing cool air for a minute under conditions in which the film surface becomes 15° C. or less and then dried by blowing 80° C. hot air to produce a dielectric multilayer film (B2).

Next, a liquid obtained by dissolving butyral resin (manufactured by SEKISUI CHEMICAL CO., LTD., S-LEC BM-S) in a methylethyl ketone solution and dispersing ATO was coated on the film with the dielectric multilayer film (B2) on which the non-interference layer N2 was produced by the extruder so that the film thickness after drying would be 10 μm. After drying, 7 low refractive index layers and 6 high refractive index layers, a total of 13 layers, were coated thereon, and set and dried to form a dielectric multilayer film (A2). The film thickness of each high refractive index layer and low refractive index layer formed is shown in Table 1. The dielectric multilayer film (A2) corresponds to the dielectric multilayer film (A) of the present invention and the dielectric multilayer film (B2) corresponds to the dielectric multilayer film (B) of the present invention.

After that, the above PET base was peeled off and then an adhesive layer was applied on the dielectric multilayer film (A2) and a hard coat layer was applied on the dielectric multilayer film (B2) in the same operation as in Example 1 to obtain an infrared shielding film 2.

### Example 3

An infrared shielding film 3 was obtained in the same manner as in the formation of the above-mentioned infrared shielding film 1 except that the dielectric multilayer film (B2) was used in place of the dielectric multilayer film (B1).

### Example 4

An infrared shielding film 4 was obtained in the same manner as in the formation of the above-mentioned infrared shielding film 4 except that the near infrared ray absorber SIR-128 was not contained in the non-interference layer N1 and an infrared absorber (ATO powders, ultra-microparticle ATO, manufactured by Sumitomo Metal Mining Co., Ltd.) was contained in the hard coat layer.

### Comparative Example 1

A comparative film 1 was obtained by coating a hard coat layer on the dielectric multilayer film (A1) and an adhesive layer on the dielectric multilayer film (B1) in the formation of the above-mentioned infrared shielding film 1, wherein the comparative film 1 has the installation direction opposite to that of the infrared shielding film 1 of the present invention.

### Comparative Example 2

A comparative film 2 was obtained in the same manner as in the formation of the above-mentioned infrared shielding film 1 except that the dielectric multilayer film (B1) was not used, that is, a hard coat layer was directly coated on the non-interference layer N1. The non-interference layer N1 is thus called for convenience, but because the dielectric multilayer film (B) is not provided in Comparative Example 2, the original function as a non-interference layer is not achieved. The layer constitution in Comparative Example 2 is shown in FIG. 4.

### Comparative Example 3

A comparative film 3 was obtained in the same manner as in the formation of the above-mentioned infrared shielding film 1 except that the dielectric multilayer film (B1), the dielectric multilayer film (A1) and an adhesive layer were coated on the non-interference layer N1 in order and a hard coat layer was directly coated on the opposite side of the non-interference layer N1. The non-interference layer N1 is thus called for convenience, but because the non-interference layer N1 is not installed between the dielectric multilayer films (A) and (B) in Comparative Example 3, the function to prevent the interference of the dielectric multilayer films (A) and (B) is not achieved. The layer constitution in Comparative Example 3 is shown in FIG. 6.

### Comparative Example 4

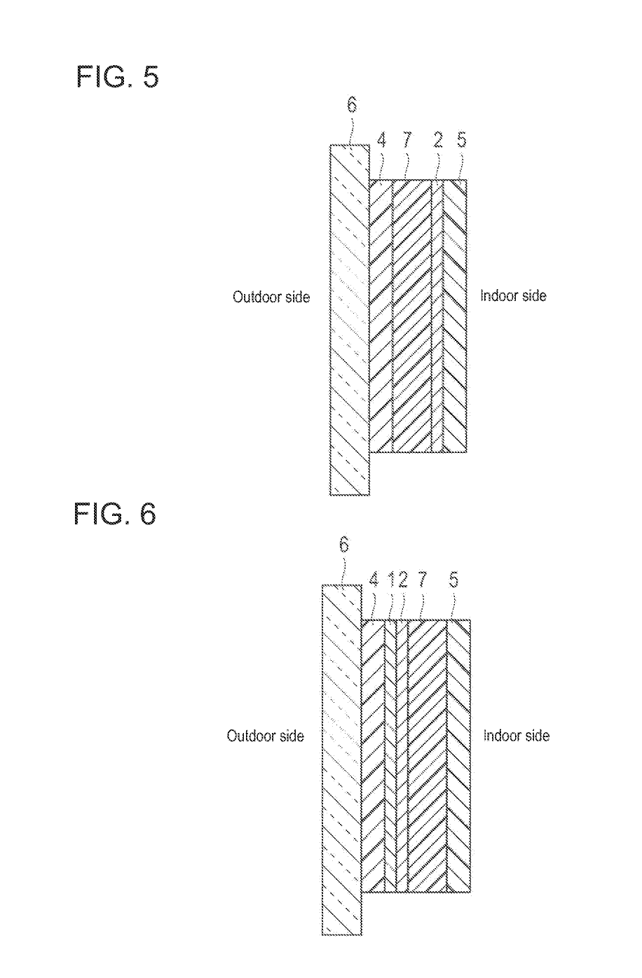

A comparative film 4 was obtained in the same manner as in the formation of the above-mentioned infrared shielding film 1 except that the dielectric multilayer film (A1) was not provided, that is, the adhesive layer was directly coated on the non-interference layer N1. The non-interference layer N1 is thus called for convenience, but because the dielectric multilayer film (A) is not provided in Comparative Example 4, the original function as a non-interference layer is not achieved. The layer constitution in Comparative Example 4 is shown in FIG. 5.

### Comparative Example 5

A comparative film 5 was obtained in the same manner as in the formation of the above-mentioned infrared shielding film 1 except that both the dielectric multilayer film (A1) and the dielectric multilayer film (B1) were not used and the adhesive layer and the hard coat layer were directly coated on the non-interference layer N1. The non-interference layer N1 is thus called for convenience, but because the dielectric multilayer films (A) and (B) are not provided in Comparative Example 5, the original function as a non-interference layer is not achieved.

### <Evaluation of Reflectance>

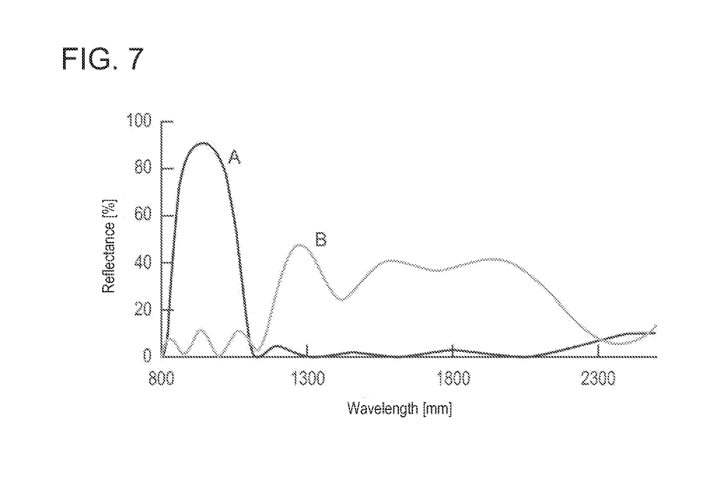

Infrared shielding films in which the dielectric multilayer film A1 was formed on one side of PET (A4300 manufactured by Toyobo Co., Ltd.: double easily adhesive layer) were each produced, and reflectance in the region of 850 to 2500 nm was measured using a spectrophotometer (using an integrating sphere, manufactured by JASCO Corporation, V-670 type). A film was installed so that light penetration when measuring would be on the reflective layer side. The results are shown in the graph A in FIG. 7. The maximum reflectance value with a reflectance of 94% in the wavelength of 950 nm was shown.

Similarly, the reflectance of the dielectric multilayer film B1 was measured. The results are shown in the graph B in FIG. 7. The maximum reflectance value with a reflectance of 46% (49% of the maximum reflectance of the dielectric multilayer film A1) in the wavelength of 1300 nm was shown. In addition, the wavelength region having a reflectance of above 20% was the range of 1000 nm from 1180 nm to 2180 nm.

Similarly, the dielectric multilayer film A2 showed the maximum reflectance value with a reflectance of 84% in the wavelength of 990 nm and the dielectric multilayer film B2 showed the maximum reflectance value with a reflectance of 41% (49% of the maximum reflectance of the dielectric multilayer film A2) in the wavelength of 1750 nm. In addition, the wavelength region having a reflectance of above 20% of the dielectric multilayer film B was the range of 750 nm from 1200 nm to 1350 nm and 1500 nm to 2100 nm.

### (Total Film Thickness Ratio)

The section of the produced infrared shielding film was observed by an electron microscope and SEM, and total film thicknesses of the dielectric multilayer film (A1 or A2) and the dielectric multilayer film (B1 or B2) were each obtained. This ratio was calculated according to the formula (1).

[Math. 2]

Total film thickness ratio %=(1−(Total film thickness of Dielectric multilayer film (B))/(Total film thickness of Dielectric multilayer film (A)))×100 formula (1)

### <Heat Crack Reducing Effect>

An infrared reflective film was pasted on the indoor side surface of a window held by an aluminum sash with 60 cm×60 cm and an incandescent lamp regarded as the sun was irradiated from the outdoor side for 10 minutes. The temperatures in the middle part of the glass and around the sash were measured by a contact thermometer. It can be said that as the temperature difference is smaller, the risk of heat cracks is lower.

### <Indoor Heat Retention Effect>

An infrared reflective film was pasted on the indoor side surface of a window held by an aluminum sash with 60 cm×60 cm and a far infrared ray heater as a heat source of heating was irradiated from the indoor side for 10 minutes. The temperatures at 1 cm away from the glass on the indoor side and outdoor side were measured by a spatial thermometer. It can be said that as the temperature difference is greater, the heat retention effect is higher.

### <Warp>

The obtained infrared shielding film was cut into a size of 60 cm×60 cm and wound on a paper core with a diameter of 3 inches, and then stored in a constant temperature oven at 58° C. for 3 days with the film in a plastic bag. After that, the film was taken out and pulled out from the paper core on a desk so that the inside of winding would turn up, and left for 30 minutes. The rising heights of the four corners on the film from the desk surface were then measured with a ruler. The average of the heights was calculated and the warping length was evaluated by the following standards:

◯: a warping length of 3 mm or less,
◯Δ: a warping length of above 3 mm and 7 mm or less,
Δ: a warping length of above 7 mm and 15 mm or less,
ΔX: a warping length of above 15 mm to 30 mm or less, and
X: a warping length of above 30 mm.

The results of each evaluation are shown in Table 2. The results of heat crack reducing evaluation showed that all infrared shielding films 1 to 4 of the present invention had a small difference in temperature between the middle part of glass and around the sash and the risk of heat cracks was reduced as compared to the comparative films 1, 4 and 5 in Comparative Examples. However, Comparative Examples 2 and 3 are inferior to the present invention in terms of the prevention of warps.

In addition, the evaluation results of indoor heat retention effect showed that all infrared shielding films 1 to 4 of the present invention had a great difference in temperature between the indoor side and the outdoor side and had excellent retention effects of the heat of heating as compared to the comparative films 1, 2 and 5 in Comparative Examples.

Further, in the visible evaluation of warps, it was shown that when the total film thickness ratio between the above dielectric multilayer film (A) and the above dielectric multilayer film (B) was within ±20%, the infrared shielding films 1 and 2 both had few warps and fewer warps than those of the comparative films 2, 3 and 4 in Comparative Examples, and application properties to a glass were excellent. In addition, because of fewer warps, the risk of film separation is reduced.

TABLE 1

| | FILM THICKNESS OF EACH LAYER (nm) | | | |
|---|---|---|---|---|
| | DIELECTRIC | DIELECTRIC | DIELECTRIC | DIELECTRIC |
| | MULTILAYER FILM | MULTILAYER FILM | MULTILAYER FILM | MULTILAYER FILM |
| | (A1) | (B1) | (A2) | (B2) |
| | FROM SIDE AWAY FROM | FROM SIDE AWAY FROM | FROM SIDE AWAY FROM | FROM SIDE AWAY FROM |
| | NON-INTERFERENCE | NON-INTERFERENCE | NON-INTERFERENCE | NON-INTERFERENCE |
| | LAYER | LAYER | LAYER | LAYER |
| LOW | 325 | 90 | 95 | 113 |
| REFRACTIVE | | | | |
| INDEX LAYER | | | | |
| HIGH | 132 | 162 | 139 | 311 |
| REFRACTIVE | | | | |
| INDEX LAYER | | | | |
| LOW | 152 | 266 | 181 | 263 |
| REFRACTIVE | | | | |
| INDEX LAYER | | | | |
| HIGH | 119 | 191 | 134 | 222 |
| REFRACTIVE | | | | |
| INDEX LAYER | | | | |
| LOW | 171 | 282 | 170 | 214 |
| REFRACTIVE | | | | |
| INDEX LAYER | | | | |
| HIGH | 128 | 371 | 127 | 230 |
| REFRACTIVE | | | | |
| INDEX LAYER | | | | |
| LOW | 156 | 325 | 164 | 207 |
| REFRACTIVE | | | | |
| INDEX LAYER | | | | |
| HIGH | 120 | 434 | 123 | — |
| REFRACTIVE | | | | |
| INDEX LAYER | | | | |
| LOW | 171 | 180 | 163 | — |
| REFRACTIVE | | | | |
| INDEX LAYER | | | | |
| HIGH | 130 | — | 127 | — |
| REFRACTIVE | | | | |
| INDEX LAYER | | | | |
| LOW | 147 | — | 170 | — |
| REFRACTIVE | | | | |
| INDEX LAYER | | | | |
| HIGH | 113 | — | 134 | — |
| REFRACTIVE | | | | |
| INDEX LAYER | | | | |
| LOW | 524 | — | 176 | — |
| REFRACTIVE | | | | |
| INDEX LAYER | | | | |

TABLE 2

| | | | | | | HEAT CRACK RE- | INDOOR HEAT RE- | |
|---|---|---|---|---|---|---|---|---|
| | OUTDOOR | INDOOR | INFRARED ABSORBER | | TOTAL | DUCING EFFECT | TENTION EFFECT | |
| | SIDE | SIDE | SITE | | FILM | SURFACE | INSIDE-OUTSIDE | |
| | CONSTI- | CONSTI- | CONTAINING | | THICKNESS | TEMPERATURE | TEMPERATURE | |
| | TUTION | TUTION | ABSORBER | TYPE | RATIO | DIFFERENCE | DIFFERENCE | WARP |
| EXAMPLE 1 | (A1) | (B1) | NON-INTERFER- | SIR-128 | 4% | 5° C. | 15° C. | ◯ |
| | | | ENCE LAYER | | | | | |
| | | | N1 | | | | | |
| EXAMPLE 2 | (A2) | (B2) | NON-INTERFER- | ATO | 18% | 8° C. | 16° C. | ◯Δ |
| | | | ENCE LAYER | | | | | |
| | | | N2 | | | | | |
| EXAMPLE 3 | (A1) | (B2) | NON-INTERFER- | SIR-128 | 35% | 6° C. | 10° C. | Δ |
| | | | ENCE LAYER | | | | | |
| | | | N1 | | | | | |
| EXAMPLE 4 | (A1) | (B2) | HARD COAT | ATO | 35% | 5° C. | 10° C. | Δ |
| | | | LAYER | | | | | |
| COMPARATIVE | (B1) | (A1) | NON-INTERFER- | SIR-128 | 4% | 13° C. | 9° C. | ◯ |
| EXAMPLE 1 | | | ENCE LAYER | | | | | |
| | | | N1 | | | | | |
| COMPARATIVE | (A1) | — | NON-INTERFER- | SIR-128 | — | 7° C. | 7° C. | X |
| EXAMPLE 2 | | | ENCE LAYER | | | | | |
| | | | N1 | | | | | |
| COMPARATIVE | (A1) | — | NON-INTERFER- | SIR-128 | — | 6° C. | 10° C. | X |
| EXAMPLE 3 | (B1) | | ENCE LAYER | | | | | |
| | | | N1 | | | | | |
| COMPARATIVE | — | (B1) | NON-INTERFER- | SIR-128 | — | 16° C. | 12° C. | ΔX |
| EXAMPLE 4 | | | ENCE LAYER | | | | | |
| | | | N1 | | | | | |
| COMPARATIVE | — | — | NON-INTERFER- | SIR-128 | — | 17° C. | 4° C. | ◯ |
| EXAMPLE 5 | | | ENCE LAYER | | | | | |
| | | | N1 | | | | | |

NOTES:
(A1), (A2), (B1) and (B2) indicate the dielectric multilayer film (A1), dielectric multilayer film (A2), dielectric multilayer film (B2) and dielectric multilayer film (B). Total film thickness ratio (%) = (1 − Total film thickness of Dielectric multilayer film (B)/Total film thickness of Dielectric multilayer film (A)) × 100

The present invention is based on Japanese patent application No. 2012-154948 filed on Jul. 10, 2012, the disclosed contents of which are cited herein by reference in its entirety.

### REFERENCE SIGNS LIST

1: Dielectric multilayer film (A)
2: Dielectric multilayer film (B)
3: Non-interference layer
4: Functional layer (adhesive layer)
5: Functional layer (hard coat layer)
6: Window glass
7: Non-interference layer N1

1. An infrared shielding film having a dielectric multilayer film (A), a dielectric multilayer film (B) and a non-interference layer disposed between the dielectric multilayer film (A) and the dielectric multilayer film (B),
wherein the dielectric multilayer film (A) has the maximum reflectance value, which has a reflectance of 50% or more, in the wavelength region of 900 to 1100 nm, and the dielectric multilayer film (B) has the maximum reflectance value in the wavelength region of 1200 to 2100 nm,
any one layer other than the dielectric multilayer film (A) and the dielectric multilayer film (B) contains an infrared absorber, and
the surface on which the dielectric multilayer film (A) is laminated is installed to face the outdoor side.

2. The infrared shielding film according to claim 1, wherein the reflectances of the dielectric multilayer film (B) in the wavelength region of 1200 to 2100 nm are 20 to 50% of the maximum reflectance in the dielectric multilayer film (A) in the wavelength region of 900 to 1100 nm.

3. The infrared shielding film according to claim 1, wherein at least one of the dielectric multilayer film (A) or the dielectric multilayer film (B) has a functional layer on the outer side thereof.

4. The infrared shielding film according to claim 1, wherein the infrared absorber is contained in a layer between the dielectric multilayer film (A) and the dielectric multilayer film (B).

5. The infrared shielding film according to claim 1, wherein the ratio of the total film thickness of the dielectric multilayer film (A) and the dielectric multilayer film (B) is within ±20%.

6. The infrared shielding film according to claim 1, wherein the surface on which the dielectric multilayer film (A) is laminated is installed to face the outdoor side and the infrared shielding film is pasted indoors.

7. A window frame body having a glass provided with an infrared shielding film according to claim 1,
wherein the surface on which the dielectric multilayer film (A) is laminated is installed to face the outdoor side.

8. A method for installing a window frame body, wherein the window frame body having a glass provided with an infrared shielding film according to claim 1 is installed so that the surface on which the dielectric multilayer film (A) is laminated will face the outdoor side.
